(19) United States
(12) Patent Application Publication
(10) Pub. No.: US 2002/0124389 A1
(43) Pub. Date: Sep. 12, 2002

(54) Order-filling distribution system and method

(76) Inventor: Kenneth D. Matson, Marietta, GA (US)

Correspondence Address: Bradley K. Groff, GARDNER GROFF & MEHRMAN, P.C., Paper Mill Village, Building 23, 600 Village Trace, Suite 300, Marietta, GA, 30067, US

(21) Appl. No.: 10/082,537

(22) Filed: Mar. 1, 2002

Related U.S. Application Data
(60) Provisional application No. 60/274,038, filed on Mar. 7, 2001.
(60) Provisional application No. 60/302,632, filed on Jul. 2, 2001.

(51) Int. Cl. B23P 19/00

(52) U.S. Cl. 29/700

(57) ABSTRACT

A system and method for filling orders and distributing products. Layer quantities of products are picked in bulk, and remaining quantities of less than a full layer quantity needed to fill orders are separately picked from a pick module. Products are distributed from the layer-picking cell and the pick module to selected assembly stations for assembly into orders.

### CROSS-REFERENCE TP RELATED APPLICATIONS

This application claims the benefit of U.S. Provisional Patent Application Serial No. 60/274,038, filed Mar. 7, 2001, and U.S. Provisional Patent Application Serial No. 60/302,632, filed Jul. 2, 2001, the entire scope and content of which are hereby incorporated herein by reference.

### BACKGROUND OF THE INVENTION

1. Field of the Invention

The present invention relates generally to distribution systems and methods for filling orders for shipping from a storage facility. The invention relates more particularly to an order filling system and method including layer-based order picking.

2. Description of Related Art

Retailers and other businesses with multiple locations that are remote from one another may benefit from economies of scale by purchasing products in quantity and distributing those goods from a central or regional distribution facility to the remote locations. Product, commonly in the form of case goods, is typically received on pallets and warehoused in a storage area of the distribution facility. Each of these “stock pallets” typically has a number of layers of cases stacked thereon, with each layer containing a number of cases (i.e., a “layer quantity”) of product. For example, a single fully-loaded stock pallet may carry four layers, each layer containing six cases of product. As used herein, the term “case” is intended to include cartons or other packages containing one or more items, one or more items bundled, strapped or otherwise bound together as a unit, and individual items, whether or not packaged or bound in any way.

As orders are processed for distribution from the distribution facility to the remote locations, one or more cases of product are typically picked from stock pallets and loaded onto a “customer pallet” for each order. Cases of different products from a number of stock pallets may be combined onto a single customer pallet during this order-picking operation. Multiple orders can be filled simultaneously by “wave picking” the combined requirements of all orders from each picking station, and distributing the requisite number of cases for each order to separate assembly stations.

The stock pallets are generally organized in a pick module containing a number of pick faces, from which cases are picked for loading onto the customer pallets. In known distribution systems, each pick face typically contains at least one pallet from which individual cases are manually picked, as required to fill an order or orders, and placed on a conveyor for transport to a customer pallet assembly station. Often, a pick station will contain one pallet from which orders are picked and one or more full pallets being held as reserve. The customer pallet is assembled at the assembly station with the ordered quantity of each product. The loaded customer pallets are then transported to the remote location that ordered the products, as by truck, rail or otherwise.

Known systems and methods for order-picking and distribution of products have been found to be unnecessarily labor-intensive and inefficient, and to occupy more space than would be desired. Accordingly, it has been found that needs exist for a system and method of order filling and product distribution that improve efficiency and reduce space requirements. It is to these and other needs that the present invention is primarily directed.

### SUMMARY OF THE INVENTION

The present invention provides a system and method of order filling and product distribution that improve efficiency and reduce space requirements, as compared to known systems and methods. The number of cases of product required from a single picking station or stock pallet for an order or a wave of orders is frequently equal to or exceeds the number of cases contained in a full layer on a stock pallet. The present invention provides a system and method of picking at least a portion of an order or wave of orders in a full-layer quantity in an automated layer picking operation. The remainder of the order or wave of orders is individually picked from a pick module. Because the remainder to be individually picked is less than a layer quantity of product, the present invention surprisingly results in improved efficiency of operation and reduced space requirements.

Briefly described, in preferred form, one aspect of the present invention is an order-filling system. The system preferably includes: a pallet storage area for storing at least one pallet carrying product arranged in at least one layer; a layer-picking cell for collecting product from a pallet in layer quantities; a pick module for picking product in less than layer quantities; and at least one assembly station for assembling orders comprising product received from at least one of the layer-picking cell and the pick module.

In another aspect, the invention is a method of filling an order. The method preferably includes the steps of: providing a stock of product comprising at least one layer; layer-picking at least a portion of the order from the stock of product; and individually picking any remainder of the order.

In still another aspect, the invention is a method of filling multiple orders simultaneously. The method preferably includes: storing a plurality of pallets at a pallet storage area, each pallet having at least one layer of product supported thereon; delivering pallets to a layer picking cell; layer-picking product from a pallet in layer quantities at the layer picking cell; distributing the layer-picked product from the layer picking cell to selected assembly stations; picking product in less than layer quantity from a pick module; distributing product picked from the pick module to selected assembly stations; and assembling orders from the product delivered to the assembly stations.

In yet another aspect, the invention is a shipping and receiving facility for filling multiple orders simultaneously. The facility preferably includes: a receiving bay for receiving products; a pallet storage area for storing a plurality of pallets, each pallet carrying product arranged in at least one layer; a layer-picking cell for collecting products from pallets in layer quantities; a pick module for picking products in less than layer quantities; a plurality of assembly stations for assembling orders from product received from the layer-picking cell and the pick module; means for transporting products between the pallet storage area and the layer-picking cell; means for distributing product from the layer-picking cell to selected assembly stations; means for distributing product from the pick module to selected assembly stations; and a delivery bay for discharging assembled orders.

These and other features and advantages of preferred forms of the present invention are described herein with reference to the drawing figures.

### BRIEF DESCRIPTION OF THE DRAWING FIGURES

FIG. 1 is a flow chart depicting sequences of operation of an order filling method according to a preferred form of the present invention.

FIG. 2 is a plan view of a system and facility according to a preferred form of the present invention.

### DETAILED DESCRIPTION

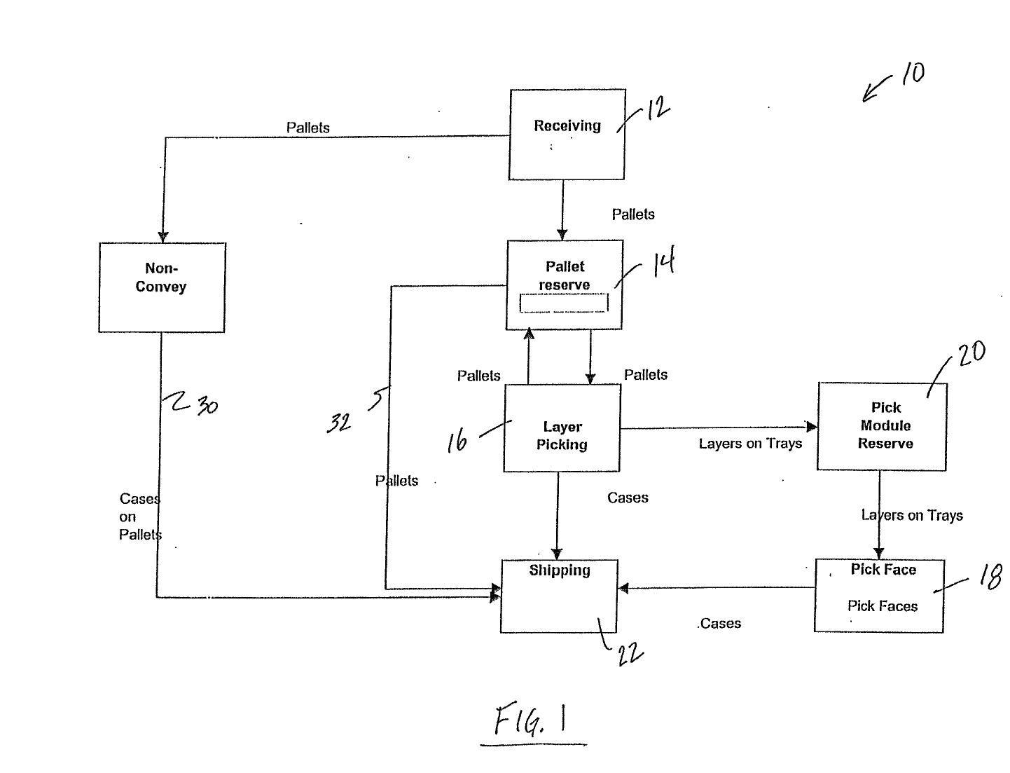

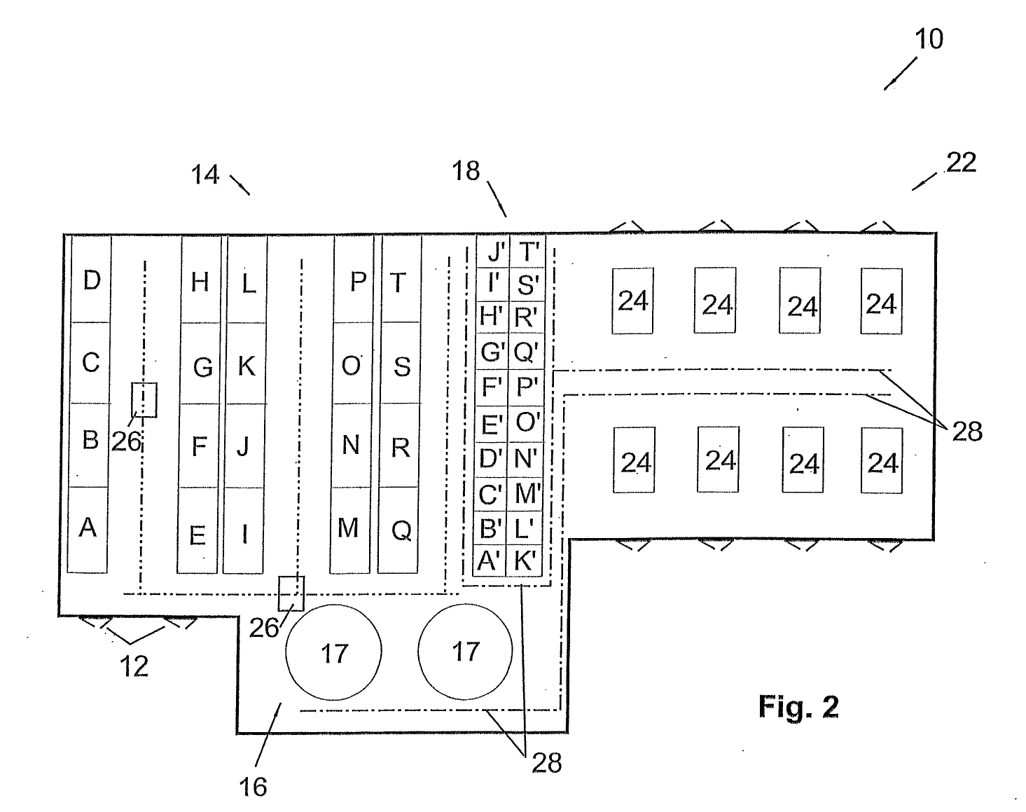

Referring now to the drawing figures wherein like reference numerals represent like parts throughout, preferred forms of the present invention will now be described. FIG. 1 shows schematically the sequence of operation of a method of filling orders and distributing product, according to a preferred form of the present invention. FIG. 2 shows an order-filling system 10 comprising a shipping and receiving facility according to a preferred form of the present invention.

Product, typically in the form of case goods, is received in a receiving bay 12 of a shipping and receiving warehouse. Alternatively, the order filling system or method of the present invention is used in a manufacturing facility, and product is received from the manufacturing line. The product is preferably stacked in one or more layers on a pallet. Preferably, the pallet is a standard size and configuration for storage and transport using forklifts, cranes and other existing equipment. Each layer on the pallet preferably comprises one or more cases, each case comprising one or more units of product.

Incoming pallets of product are transported to a pallet reserve or storage area 14, using a forklift, crane or other transport mechanism. The pallet storage area 14 preferably comprises a plurality of racks, bays or other segregated storage locations, whereby different products are received and stored, each product having a specified storage location A-T. The storage area 14 preferably comprises at least one pallet of each type of product expected to be needed to fill orders. Optionally, two or more pallets of each type of product are stored, providing sufficient reserve quantities of product to fulfill expected orders for a predetermined period of time (e.g., a daily, weekly or monthly reserve). For example, the storage area can comprises a “working” pallet, from which layers of product are removed to fill orders, and one or more “reserve” pallets. Each reserve pallet will preferably remain fully loaded, whereas the working pallet may comprise a full pallet less one or more layers of product. When the working pallet is emptied of product, one of the reserve pallets will become the working pallet. Preferably, only pallets comprising one or more full layers of product are stored in the storage area 14. For simplicity, FIG. 2 depicts a facility with 20 different products, A-T. Of course, it will be understood that the present invention encompasses facilities accommodating more or fewer products.

The system 10 of the present invention preferably further comprises a layer picking cell 16. The layer picking cell 16 preferably collects layer quantities (i.e., the quantity of product comprising a full layer on a pallet) of product from a pallet of product as needed to fill orders. The layer picking cell 16 can be in a separate location, away from the storage area 14, or can be within the storage area 14. The layer picking step is preferably automated, and is preferably computer-controlled as detailed further below. Alternatively, some or all of the layer picking is carried out manually. One or more unscramblers are preferably provided for separating cases of product from the removed layer quantity of product and distributing the cases to one or more assembly stations (described below) to fill multiple orders.

The system 10 preferably further comprises a layer-based pick module 18 for individually picking less than layer quantities of product needed to fill orders, in an operation separate from the layer picking step. In preferred form, the pick module 18 comprises a plurality of pick faces A′-T′, whereby each type of product expected to be needed to fill orders is contained in a separate pick face of the pick module 18. Pick faces A′-T′ respectively correspond to storage racks A-T of the storage area 14, with the same product being contained in a pick face and its corresponding storage rack. Each pick face preferably contains not more than a layer quantity of product, thereby minimizing the space occupied. Optionally, a pick module reserve 20 is provided, whereby layer quantities of product are placed on trays or otherwise held in reserve, for replenishing the pick face as it is emptied of product. The individual picking of less than layer quantities of product from the pick faces is typically carried out manually. Alternatively, some or all of the individual picking may be automated and computer-controlled.

A shipping portion 22 of the system 10 of the present invention preferably comprises one or more assembly stations 24. Each assembly station 24 preferably receives product from the layer picking cell 16 and the pick module 18 to assemble an order. One or more shipping bays are preferably provided for discharging assembled orders for loading onto transport vehicles. If orders are to be shipped to individual stores, each store is preferably assigned an assembly station and an associated shipping bay in a “one-store-per-door” arrangement. Alternatively, if orders are to be shipped to one or more distribution sub-centers that in turn service multiple stores, a shipping bay is assigned to each distribution sub-center, and an assembly station for each store served by the distribution sub-center is arranged proximal the shipping bay. The assembled order is then delivered to a remote location, such as a store or a distribution sub-center.

The system 10 of the present invention preferably further comprises one or more automated storage and retrieval systems, and/or one or more product conveyors for transporting product between the various segments of the system. For example, the system 10 preferably comprises one or more aisle-changing cranes 26 for transporting pallets of product to and from the pallet storage area 14, and one or more belt or roller conveyors 28 for transporting product to and from the pick module 18 and the assembly stations 24.

The system 10 of the present invention enables a method of filling one or more orders. With reference again to FIG. 1, the method of the present invention preferably comprises filling an order by providing a stock of product comprising at least one layer, layer-picking at least a portion of the order from the stock of product, and separately picking any remainder of the order. The stock of product, for example, is stored in the storage area 14, described in greater detail above, the layer picking cell 16 picks one or more layer quantities comprising at least a portion of the order, and the remainder of the order is picked in the pick module 18. For example, if an order requires fifteen units of a product, and the product is palletized in layers of six units per layer, two layers (twelve units are preferably picked in the layer picking step and the remainder (three units) are separately picked as individual units. For maximum efficiency, the number of units picked by the layer picking step is preferably the highest whole number multiple of the layer quantity that does not exceed the number of units needed to fill the order. In this manner, the remainder needed to complete the order is always less than a full layer quantity. Advantageously, this method reduces the time and/or labor required for picking individual units, and also reduces the number of units that need to be stored in the pick module. By reducing the number of units of product stored in the pick module, the size of the pick faces is likewise reduced. This further improves efficiency, as there is less distance to traverse between pick faces.

The layer-picked product and the individually picked product are preferably transported to an assembly station 24 for assembling an order. Continuing the above example, the twelve layer-picked units and the three separately-picked units are assembled into an order totaling fifteen units. Optionally, if the ordered quantity is equal to or greater than the number of units of product on a full pallet, one or more full pallets are transported directly from the receiving bay 12 (path 30 on FIG. 1) or from the pallet storage area 14 (path 32 on FIG. 1) to the assembly station 24.

The method of the present invention optionally further comprises stocking the pick module 18 from the layer picking cell 16. As product is depleted from any pick face of the pick module 18, and reaches a predetermined “low” level, a layer of product is preferably collected from a pallet in the corresponding rack of the storage area 14 using the layer picking cell 16, and transferred to the pick module 18. If the system includes a pick module reserve 20, upon reaching a predetermined low level in any pick face, one or more units of product are preferably transferred from the pick module reserve to the pick face. The pick module reserve 20 is preferably replenished from a pallet of the storage area 14 using the layer picking cell 16 upon reaching a predetermined low level of a product in the pick module reserve. In a further preferred and optional embodiment, if one or more layers of product remain on a pallet after the layer-picked products are collected in the layer picking cell for filling an order, the system checks the level of product remaining in the pick module 18 (and if present the pick module reserve 20) and selects between: (i) returning the pallet and all remaining product thereon to the pallet storage area 14; or (ii) delivering some or all of the product remaining on the pallet to the pick module 18 or the pick module reserve 20.

The system and method of the present invention, as described above, preferably enable the filling of multiple orders simultaneously. For example, it is not unusual for a distribution center to fill orders for fifty to one-hundred or more stores. In order to increase efficiency by maximizing the percentage of units of product collected in the automated layer picking step rather than in the individual picking step, it is preferable that the orders for as many stores as possible be filled simultaneously in one large multi-store wave per day (or per shift, etc.). For each product A-T ordered, the total quantity of product needed to fill all orders is determined. One or more layer quantities of product are collected from storage area 14 via the layer picking cell 16, preferably equaling the highest whole number multiple of the layer quantity that does not exceed the total quantity of units needed to fill all orders. In this manner, any remaining quantity of product needed to fill all orders is necessarily less than the layer quantity. The remaining quantity of product needed to fill all orders is determined, and is individually picked from the pick module 18. The layer picked product and the individually picked product are then distributed to selected assembly stations in the quantity needed to fill the order corresponding to each assembly station 24. The above steps are repeated for each product A-T ordered, and the orders are assembled at the assembly stations. Preferably, the layer picking step and the individual product picking step for each product are carried out at about the same time.

The system and method of the present invention are preferably automated and computer controlled. For example, the system of the present invention preferably comprises a control system comprising a programmable computer and software installed thereon for implementing the method described herein. The pallet storage area 14, the pick module reserve 20, and/or the pick module 18 preferably comprise one or more sensors for monitoring the quantity of product therein and communicating this information to the computer control system. By monitoring the quantity of product in the various locations, the control system enables automated re-stocking and transfer of product. The control system preferably receives input information regarding the orders to be filled, the inventory of product at various locations in the system, and the status of the order-filling process. The control system carries out programmed instructions and outputs control signals for controlling the various components of the system according to the above-described method. The present invention further comprises software in computer-readable media for implementing the method described herein.

While the invention has been described in its preferred forms, it will be readily apparent to those of ordinary skill in the art that many additions, modifications and deletions can be made thereto without departing from the spirit and scope of the invention.

### what is claimed is:

1. An order-filling system comprising:
a pallet storage area for storing at least one pallet carrying product arranged in at least one layer;
a layer-picking cell for collecting product from a pallet in layer quantities;
a pick module for picking product in less than layer quantities; and
at least one assembly station for assembling orders comprising product received from at least one of said layer-picking cell and said pick module.

2. The order-filling system of claim 1, wherein said pick module comprises at least one pick face, each pick face containing not more than a layer quantity of product.

3. The order-filling system of claim 1, further comprising means for transporting product between said pallet storage area and said layer-picking cell.

4. The order-filling system of claim 1, further comprising means for transporting product between said pick module and said assembly station.

5. The order-filling system of claim 1, further comprising means for transporting product between said layer-picking cell and said assembly station.

6. The order-filling system of claim 1, further comprising an unscrambler for distributing product from said layer-picking cell to a plurality of assembly stations.

7. The order-filling system of claim 1, wherein product remaining on pallets after discharge from said layer-picking cell is returned to said pallet storage area or transferred to said pick module.

8. The order-filling system of claim 1, further comprising means for stocking said pick module from said layer-picking cell.

9. A method of filling an order, comprising:
providing a stock of product comprising at least one layer;
layer-picking at least a portion of the order from the stock of product; and
individually picking any remainder of the order.

10. The method of claim 9, wherein multiple orders are filled simultaneously.

11. The method of claim 10, further comprising transporting layer-picked product and individually picked product to a plurality of assembly stations and assembling each order at an assembly station.

12. The method of claim 9, further comprising distributing layer-picked product to a plurality of assembly stations.

13. The method of claim 9, wherein after the step of layer-picking at least a portion of the order from the stock of product, the method further comprises selecting between: (i) returning remaining product to a storage area; and (ii) delivering remaining product to a pick module.

14. A method of filling multiple orders simultaneously, said method comprising:
storing a plurality of pallets at a pallet storage area, each pallet having at least one layer of product supported thereon;
delivering pallets to a layer picking cell;
layer-picking product from a pallet in layer quantities at the layer picking cell;
distributing the layer-picked product from the layer picking cell to selected assembly stations;
picking product in less than layer quantity from a pick module;
distributing product picked from the pick module to selected assembly stations; and
assembling orders from the product delivered to the assembly stations.

15. The method of claim 14, further comprising delivering the assembled orders to remote locations.

16. The method of claim 14, further comprising stocking the pick module from the layer picking cell.

17. The method of claim 14, further comprising delivering a pallet of product from the pallet storage area to an assembly station.

18. A distribution facility for filling multiple orders simultaneously, said facility comprising:
a receiving bay for receiving products;
a pallet storage area for storing a plurality of pallets, each pallet carrying product arranged in at least one layer;
a layer-picking cell for collecting products from pallets in layer quantities;
a pick module for picking products in less than layer quantities;
a plurality of assembly stations for assembling orders from product received from said layer-picking cell and said pick module;
means for distributing product from said layer-picking cell to selected assembly stations;
means for distributing product from said pick module to selected assembly stations; and
a delivery bay for discharging assembled orders.

19. The distribution facility of claim 18, wherein said pick module comprises at least one pick face, each pick face containing not more than a layer quantity of product.

20. The distribution facility of claim 18, further comprising means for stocking said pick module from said layer-picking cell.
